(19) United States
(12) Patent Application Publication
(10) Pub. No.: US 2010/0174734 A1
(43) Pub. Date: Jul. 8, 2010

(54) ASYNCHRONOUS DATABASE UPDATES BETWEEN COLLABORATIVE APPLICATIONS AND SEARCH UTILITIES

(75) Inventors: Alan Tarik Norbauer, Beverly, MA (US); Alexei Evdokimov, Swampscott, MA (US); Ransom Lloyd Richardson, Beverly, MA (US); Seth David Goldstein, Exeter, NH (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/348,019

(22) Filed: Jan. 2, 2009

(51) Int. Cl. G06F 17/30; G06F 12/00; G06F 7/00

(52) U.S. Cl. 707/769; 707/E17.014; 707/E17.044; 711/E12.001; 707/611

(57) ABSTRACT

Tools and techniques for asynchronous database updates between client applications and search utilities are provided. These tools may receive indications of updates occurring within a workspace in which two or more users are collaborating. Updates to the collaborative workspace may be committed to a collaboration database maintained internally by a collaboration application. The tools may generate request to commit these updates to a search utility, so that the updates are searchable. The search utility maintains a search database that is decoupled from and operates independently of the collaboration database. The tools may increment a notification counter associated with the collaborative workspace, with the notification counter tracking how many requests to commit updates are pending. Finally, the tools may send the request to commit the update to the search database asynchronously with respect to the collaboration database.

### BACKGROUND

Collaboration applications enable two or more users to collaborate within a given workspace for example, to edit content. The collaborating users typically operate different computer systems. These different computer systems may include search utilities that enable the users to search for particular items located on the computer systems.

### SUMMARY

Tools and techniques for asynchronous database updates between client applications and search utilities are provided. These tools may receive indications of updates occurring within a workspace in which two or more users are collaborating. Updates to the collaborative workspace may be committed to a collaboration database maintained internally by a collaboration application. The tools may generate request to commit these updates to a search utility, so that the updates are searchable. The search utility maintains a search database that is decoupled from and operates independently of the collaboration database. The tools may increment a notification counter associated with the collaborative workspace, with the notification counter tracking how many requests to commit updates are pending. Finally, the tools may send the request to commit the update to the search database asynchronously with respect to the collaboration database.

It should be appreciated that the above-described subject matter may be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a combined block and flow diagram illustrating systems or operating environments suitable for implementing asynchronous database updates between client applications and search utilities.

FIG. 2 is a combined block and flow diagram illustrating examples of updates and related notifications that may flow from a collaborative workspace through an asynchronous update utility to the search utility.

FIG. 3 is a flow diagram illustrating overall processes related to performing asynchronous database updates between client applications and search utilities.

FIG. 4 is a flow diagram illustrating process flows related to asynchronous database updates between client applications and search utilities, particularly in cases when a given commit operation is successful.

FIGS. 5 and 6 are flow diagrams illustrating process flows related to asynchronous database updates between client applications and search utilities, particularly in cases where the given commit operation is at least initially unsuccessful.

### DETAILED DESCRIPTION

The following detailed description provides tools and techniques for asynchronous database updates between client applications and search utilities. While the subject matter described herein presents a general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

The following detailed description refers to the accompanying drawings that form a part hereof, and that show, by way of illustration, specific example implementations. Referring now to the drawings, in which like numerals represent like elements through the several figures, this description provides various tools and techniques for asynchronous database updates between client applications and search utilities.

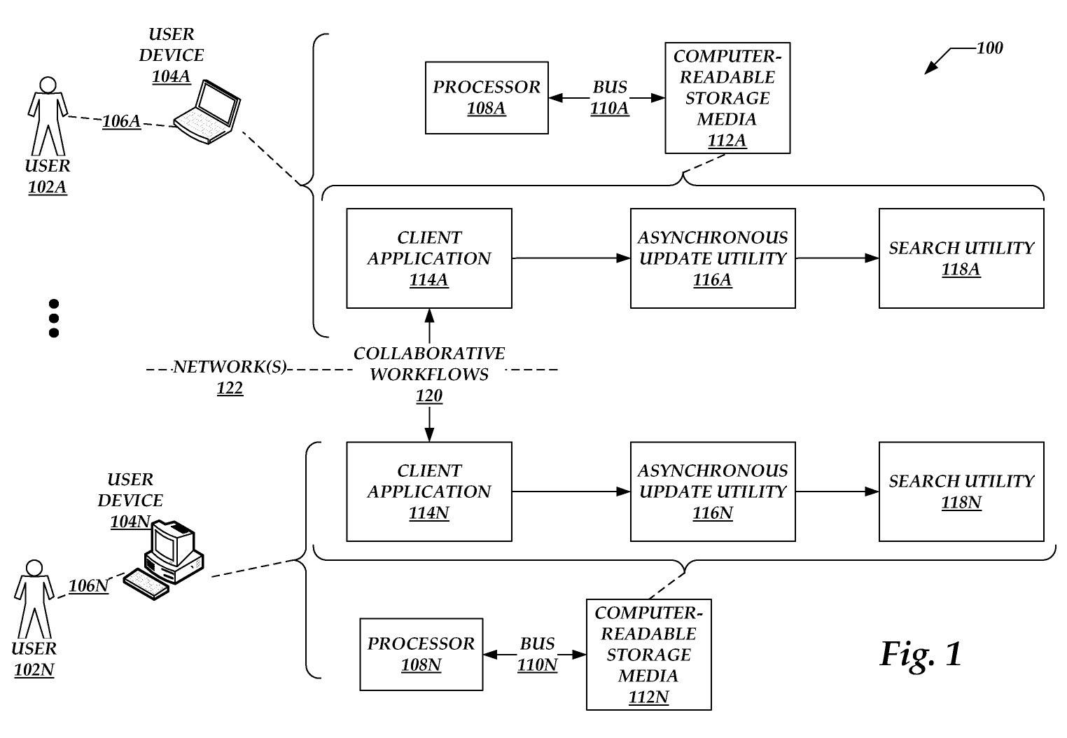

FIG. 1 illustrates systems or operating environments, denoted generally at 100, suitable for implementing asynchronous database updates between client applications and search utilities. Turning to FIG. 1 in more detail, any number of users 102a and 102n (collectively, users 102) may interact with corresponding user devices 104a and 104n (collectively, user devices 104). FIG. 1 represents these interactions respectively at 106a and 106n (collectively, interactions 106). In general, these interactions 106 may denote commands issued by the users to the devices 104, responses to these commands, and the like, in connection with asynchronous database updates between client applications and search utilities.

Turning to the user devices 104 in more detail, these user devices 104 as shown in FIG. 1 may represent any number of such devices. In addition, the graphical representations of the user devices as presented in FIG. 1 are chosen only for convenience of illustration, but not to limit possible implementations. More specifically, the user devices 104 may include, but are not limited to: relatively stationary desktop computing systems; laptop notebook, or other relatively mobile computing systems; wireless communications devices, such as cellular phones, smartphones, wireless-enabled personal digital assistants (PDAs), or other similar communications devices.

A given user device 104 may cooperate with any number of other user devices 104 in connection with performing asynchronous database updates between client applications and search utilities. For example, different ones of the user devices 104 may cooperate in a client-server relationship, a peer-to-peer relationship, or any other suitable relationship as appropriate for different implementations.

In addition, although omitted from FIG. 1 in the interests of clarity, the user devices 104 may also cooperate with the server systems in some implementations. In general, the description provided herein relating to processes performed within a given user device 104, or between two or more of the user devices 104, may also apply to implementations incorporating such server systems.

Turning to the user devices 104a and 104n in more detail, respectively, these systems may include one or more processors 108a and 108n (collectively, processors 108), which may have a particular type or architecture, chosen as appropriate for particular implementations. The type and architecture of the processor 108a may or may not be the same as the type or architecture of the processor 108n.

The processors 108a and 108n may couple to one or more bus systems 110a and 110n (collectively, bus systems 110), having type and/or architecture that is chosen for compatibility with the processors 108a and 108n, respectively. As noted above with the processors 108, the bus systems 110a and 110n may or may not have the same type and/or architecture.

The user devices 104a and 104n may also include one or more instances of computer-readable storage medium or media 112a and 112n (collectively, storage media 112), which couple respectively to the bus systems 110a and 110n. The bus systems 110 may enable the processors 108 to read code and/or data to/from the computer-readable storage media 112. The media 112 may represent apparatus in the form of storage elements that are implemented using any suitable technology, including but not limited to semiconductors, magnetic materials, optics, or the like. The media 112 may include memory components, whether classified as RAM, ROM, flash, or other types, and may also represent hard disk drives.

The storage media 112 may include one or more modules of instructions that, when loaded into the processor 108 and executed, cause the user devices 104 to perform various techniques related to asynchronous database updates between client applications and search utilities. As detailed throughout this description, these modules of instructions may also provide various tools or techniques by which the user devices may perform asynchronous database updates between client applications and search utilities, using the components, flows, and data structures discussed in more detail throughout this description. For example, the storage media 112 may include one or more software modules that implement client applications 114a and 114n (collectively, client applications 114), asynchronous update utilities 116a and 116n (collectively, asynchronous update utilities 116), and desktop search utilities 118a and 118n (collectively, desktop search utilities 118).

The client applications 114, asynchronous update utilities 116, and desktop search utilities 118 as shown in FIG. 1 generally represent software programmed or configured to perform various functions allocated herein to various components of the user devices 104. Subsequent description provides further detail regarding the operations of the client application 114, the asynchronous update utility 116, and the desktop search utility 118. However, in overview, the client application 114 may represent software applications that enable any number of users 104 to cooperate or collaborate with one another on common tasks. For example, the client applications 114a and 114n may exchange collaborative workflows 120 with one another, with these collaborative workflows passing over one or more suitable communications networks 122.

Referring to the search utility 118 in more detail, this utility may represent any utility that is external to the client application 114, with the term “search utility” chosen only to facilitate this present description but not to limit possible implementations of this description. More specifically, this utility 118 may store its data separately from the client application 114, for example, in a separate opaque database or file store.

Turning to the collaborative workflows 120 in more detail, these workflows may represent updates made by different users 102 to a common shared workspace. For example, a given user 102a may create some revisions to the shared workspace, while another given user 102n creates other revisions to the shared workspace. In operation, the client application 114a may transmit revisions made by the user 102a over the network 122 to the client application 114n. In turn, the client application 114n may integrate (or “sync”) these revisions made by the user 102a into revisions made by the user 102n. Likewise, the client application 114n may also revisions made by the user 102n over the network 122 to the client application 114a. Accordingly, FIG. 1 shows the collaboration flows 120 as bidirectional in nature.

Examples of the client applications 114 may include, but are not limited to, the GROOVE® software available from Microsoft Corporation of Redmond Wash. However, examples of the client applications 114 may also include other software that is available from other vendors and that offers similar capabilities to those provided in this description. Although this description may refer to collaborative applications and workspaces, at least portions of this description may be implemented in any application that stores searchable data in a database. Further examples of implementation scenarios may involve one database or related management system that commits changes to another database. In addition, the client applications 114 may represent applications that are off-line relative to one or more server systems.

Turning to the search utilities 118 in more detail, these utilities 118 may represent, for example, utilities that enable a given user 102 to search content contained within the user devices 104. Without limiting possible implementations, this description may refer to such utilities 118 as “desktop search” utilities or services. In more detail, the search utilities 118 may receive input search strings, keywords, or other search parameters (collectively, search parameters) from the users 102. Examples of search parameters may include names or titles of particular documents or files, text strings occurring within such files, dates and/or times that such files are created or modified, file extensions associated with such documents, and the like. In turn, the search utilities 118 may attempt to locate any occurrences of the input search parameters within file or document storage provided by the user devices 104. The search utilities 118 may then return any files or documents containing hits for the input search parameters.

Turning to the asynchronous update utilities 116 in more detail, these update utilities 116 may operate to make content that is created or modified using the client applications 114 searchable using the search utilities 118. For example, the users 102a and 102n may collaborate on creating and editing a given document using respective instances of the client applications 114a and 114n. in such a scenario, the asynchronous update utilities 116a and 116n may make this given document searchable within the user devices 104a and 104n, using the search utilities 118. Put differently, the asynchronous update utilities 116 may execute any number of transactions by which content is updated from the client applications 114 to the search utilities 118, thereby making this content searchable in the context of the entire user devices 104.

FIG. 1 illustrates the asynchronous update utilities 116 as separate entities from the client applications 114 and the search utilities 118 only for convenience of reference and illustration, but not to limit possible implementations. For example, software instructions implemented in the functions allocated to the asynchronous update utilities 116 may or may not be in modules separate from the client applications 114 and the search utilities. In some implementations, the functions allocated to the asynchronous update utilities 116 may be integrated into the client applications 114.

Turning to the networks 122 in more detail, these networks 122 may represent one or more communications networks. For example, the networks 122 may represent local area networks (LANs), wide area networks (WANs), and/or personal area networks (e.g., Bluetooth-type networks), any of which may operate alone or in combination to facilitate asynchronous database updates between client applications and search utilities. The networks 122 as shown in FIG. 1 also represents any hardware (e.g., adapters, interfaces, cables, and the like), software, or firmware associated with implementing these networks, and may also represent any protocols by which these networks may operate.

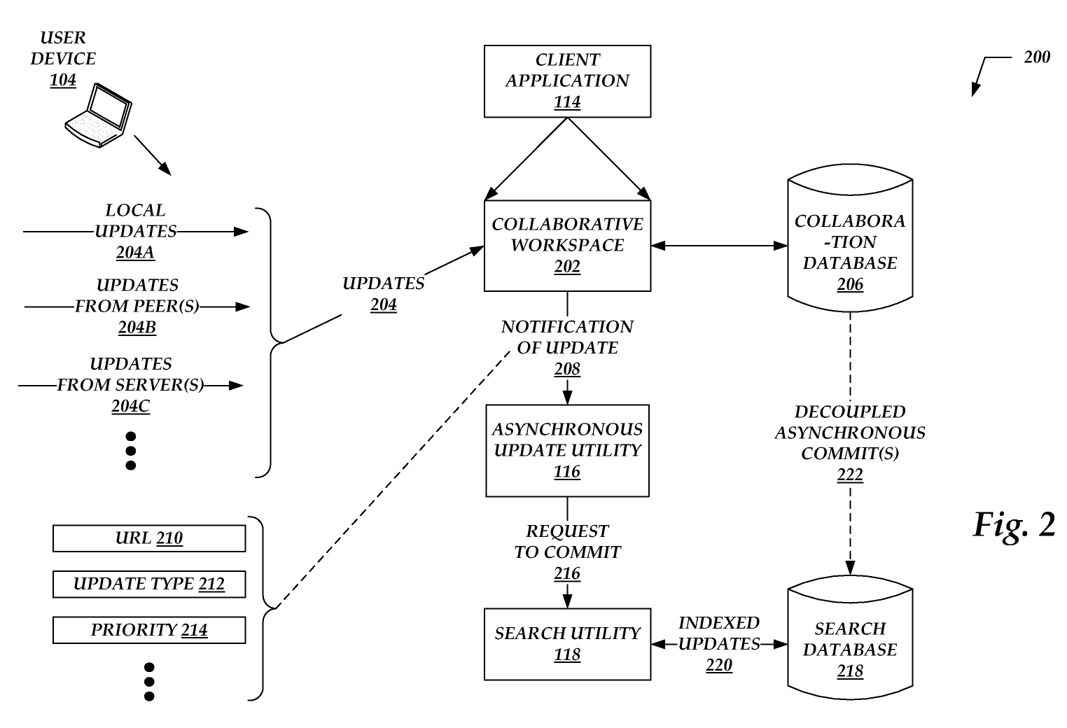

FIG. 2 illustrates examples of updates and related notifications that may flow from a collaborative workspace through an asynchronous update utility to the search utility. For ease of reference and description, but not to limit possible implementations, FIG. 2 carries forward an example user device 104, which may include a representative client application 114, a representative asynchronous update utility 116, and a representative search utility 118, all of which are described above with FIG. 1.

Turning to FIG. 2, the client application 114 may provide, maintain, and support any number of collaborative workspaces 202 within the context of a given user device 104. FIG. 2 illustrates one collaborative workspace 202 only for clarity of illustration. However, limitations of this description may include any number of the collaborative workspaces 202 at any given time. Through these collaborative workspaces 202, different collaborating users (e.g., 102a and 102n in FIG. 1) may collaboratively create and edit documents remotely from one another. More specifically, the collaborative workspaces 202 may receive various updates to the workspaces, with the example updates denoted generally at 204.

Turning to the updates 204 in more detail, examples of these updates may include updates or revisions occurring locally on the given user device 104. For example, a local user may revise, delete, add or otherwise update content locally at the user device 104. FIG. 2 denotes these local updates generally at 204a. As described above, the client application 114 may sync such local updates to any other users collaborating within the collaborative workspace 202.

In other examples, the updates 204 may include updates created by other users collaborating within the workspace 202, and synced-in from those other users. Without limiting possible implementations, this description refers to such other users as “peers”, with respect to a given workspace 202. FIG. 2 generally represents at 204b updates as synced-in from such peers.

In other scenarios, the updates 204 may include updates received or sync-in from server-based collaboration systems or centralized document repositories. Examples of such server-based collaboration systems and related services may include, but are not limited to, the SHAREPOINT® services available from Microsoft Corporation of Redmond, Wash., as well as other services and software that provide similar functionality, as available from other vendors. FIG. 2 generally represents at 204c updates as received from such server-based systems.

As the updates 204 arrive over time, the client application 114 may store these updates in one or more collaboration databases 206. In general, the collaboration databases 206 store and maintain information representing states of different workspaces 202. Typically, the client application 114 maintains the collaboration database 206 internally, and does not expose the database 206 outside of the application 114. Therefore, the collaboration database 206 is typically decoupled from any databases external to the client application 114. Implementations of this description may choose any number of different schemas, formats, record layouts, or other features of the collaboration databases 206, selected as appropriate depending on the circumstances of a given application.

In addition to storing representations of the updates 204 within the collaboration database 206, the client application 114 may also provide notifications 208 to the asynchronous update utility 116. In example implementations, these notifications 208 may include representations 210 of a Universal Resource Locator (URL) from which the updates may be loaded. At any convenient point, the asynchronous update utility 116 or the search utility 118 may access the URL to obtain the update. In other implementations, the updates themselves may be loaded directly into the notification 208.

The notifications 208 may indicate a type of update, as represented generally at 212. For example, update types 212 may indicate that a given update is a new record, an updated record, a deleted record, or other suitable type as appropriate in a given implementation.

In some cases, the notifications 208 may indicate a priority or urgency level associated with a given update, as represented generally at 214. Examples of different priority levels may include high, medium, low, or the like, as appropriate in different implementations.

The asynchronous update utility may receive the update notifications 208, and may in turn request that the search utility 118 commit the update, to make the content represented in the update searchable within the user device 104. FIG. 2 represents at 216 these requests to commit, as well as responses to these requests.

Referring to the search utility 118 in more detail, this utility may maintain one or more search databases 218. Typically, these search databases 218 are separate and decoupled from the collaboration databases 206, which as described above are maintained internally by the client application 114. In general, the search databases 218 may store inverted indexes representing searchable information locatable within the user devices 104. More specifically, searchable information typically resides within the computer-readable storage media 112, and the search databases 218 may store indexes defined over searchable content within the storage media 112.

When the search utility 118 receives a given request to commit 216, the search utility 118 may index the updates represented in the request 216. FIG. 2 represents the indexed updates at 220. As described in further detail below, the search utility 118 may or may not successfully respond to all of the requests 216. Assuming, however, that the search utility 118 successfully indexes and commits a given request 216, the asynchronous update utility 116 may accomplish a decoupled asynchronous commit between the collaboration database 206 and the search database 218. FIG. 2 represents this decoupled asynchronous commit at 222.

Turning to the decoupled asynchronous commit 222 in more detail, this description refers to this commit as “asynchronous” in the sense that successes or failures to update the search database 218 are independent of the state of the collaboration database 206. In other words, states of the collaboration database 206 are maintained separately, and do not depend upon, states of the search database 218. Accordingly, the collaboration database 206 is described as being “decoupled” from the search database 218.

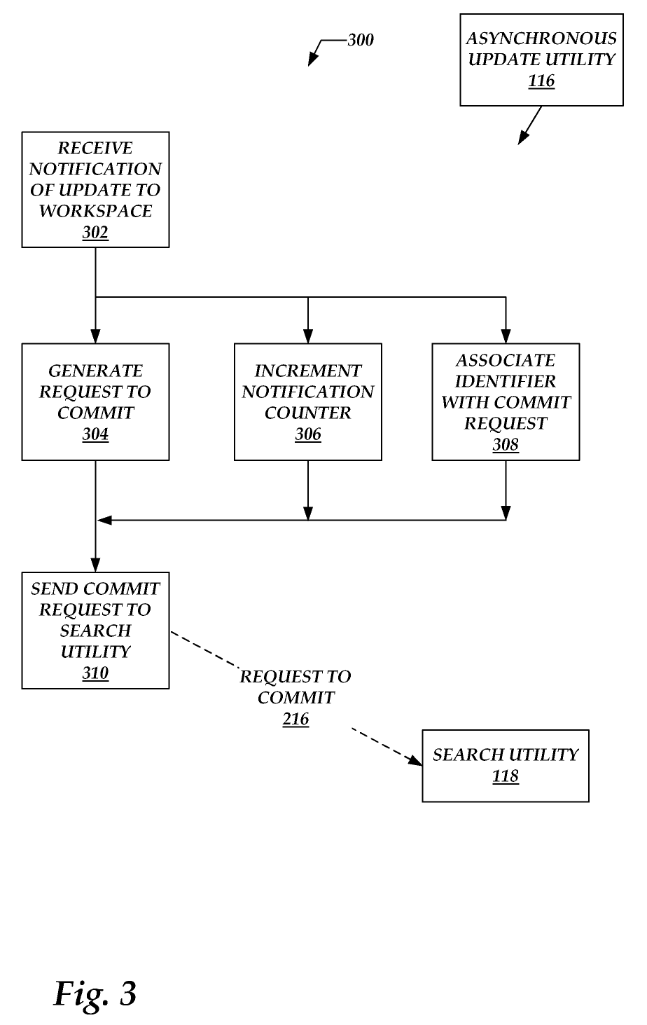

FIG. 3 illustrates overall processes, denoted generally at 300, related to performing asynchronous database updates between client applications and search utilities. Without limiting possible implementations, this description discusses the processes 300 in connection with the above asynchronous update utility 116. However, implementations of this description may perform at least portions of the process flows 300 in connection with other components or utilities, without departing from the scope and spirit of the present description.

Turning to the processes 300 in more detail, block 302 represents receiving notification of a given update to a given collaborative workspace. FIG. 2 provides examples of collaborative workspaces at 202, and provides examples of different types of updates at 204a-204c. FIG. 2 also provides an example of an update notification at 208. Block 302 may include receiving such an update notification 208 from the client application 114.

Block 304 represents generating a request to commit the update received in block 302. FIG. 2 provides examples of such a request to commit at 216.

Block 306 represents incrementing a counter that tracks how many requests to commit are outstanding at a given time. Block 306 may include storing the count in the collaboration database (e.g., 206 in FIG. 2), and may include incrementing the count within the same transaction as any change to the collaboration database. Put differently, the counter is incremented transactionally, such that if the database transaction is committed and the client application's data is changed, the counter is incremented. An instance of the counter may be associated with each collaboration workspace. In turn, the collaboration workspace may be implemented within a database.

The level at which the counter is stored and associated may vary in different implementations. For example, some implementations may associate the counter with an entire database, while other implementations may associate a counter with more granular information that is committed to the database (e.g., one counter per individual record or item committed). These different possible implementations reflect different resolutions to tradeoffs between performance during steady-state or “normal” operations, as balanced against efficiency when recovering from errors or “abnormal” situations.

In this manner, block 306 may enable the asynchronous update utility to detect when notifications are lost, and when to do a full crawl to commit such lost notifications. Crawl processes are described in further detail below. However, in overview, a full crawl may entail traversing a history of previous changes or updates to the collaboration database, and attempting to commit these previous changes.

As described in further detail below, if the search utility 118 commits a given update successfully to the search database 218, the counter incremented in block 306 may be decremented, since one less request to commit is outstanding in that case. However, so long as the search utility 118 is unable to commit the given update successfully to the search database 218, the counter remains incremented. If the client application 114 crashes while the counter remains incremented, this incremented counter indicates that at least one update was not completely committed to the search database before the crash. When the client application 114 restarts, the application may examine the state of the counter. If the counter is in an incremented state, the application may initiate a full crawl to commit any lost changes to the collaboration database 206.

The above processing of the count (e.g., before and after crashes) illustrates processing tradeoffs. For example, the asynchronous update utility 116 may simplify processing by incrementing and storing the count in connection with committing particular updates to the collaboration database 206. In this manner, the asynchronous update utility 116 may perform limited “bookkeeping” for each individual transaction that occurs, and may defer more substantial or computationally-intensive processing until an update fails to commit. Once a transaction fails to commit (e.g., as indicated by an incremented count detected during a post-crash restart), however, the client application may have limited information to act upon. With this limited information at hand, the application may initiate a full crawl of the workspace to commit any updates or changes that failed to commit before (resulting in the incremented counter).

Block 308 represents associating an identifier with the given request to commit an update. In this manner, subsequent processing may track the status of the given request to commit. For example, if the search utility successfully commits an update of a given workspace, the asynchronous update utility may report this success back to the originating workspace using this identifier. Conversely, this identifier may also enable tracking of unsuccessful requests to commit updates. In different implementations, the asynchronous update utility 116 may or may not expose this identifier to the search utility 118.

Block 310 represents sending to the search utility the request 216 to commit updates. To provide context, FIG. 3 carries forward an example request to commit at 216, as directed to the search utility 118.

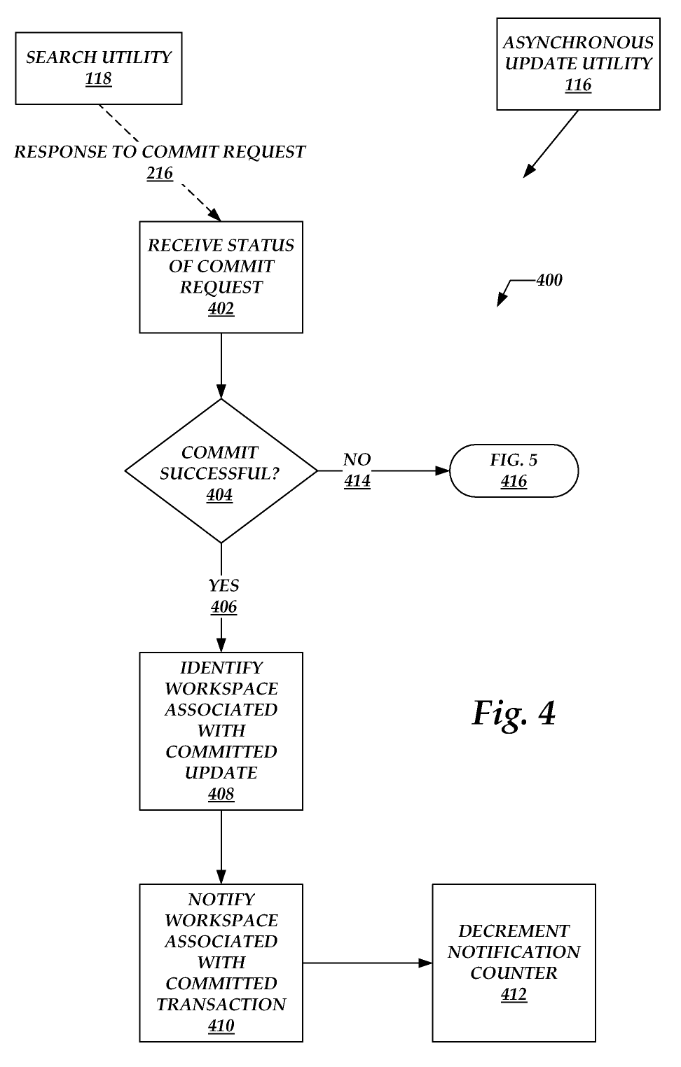

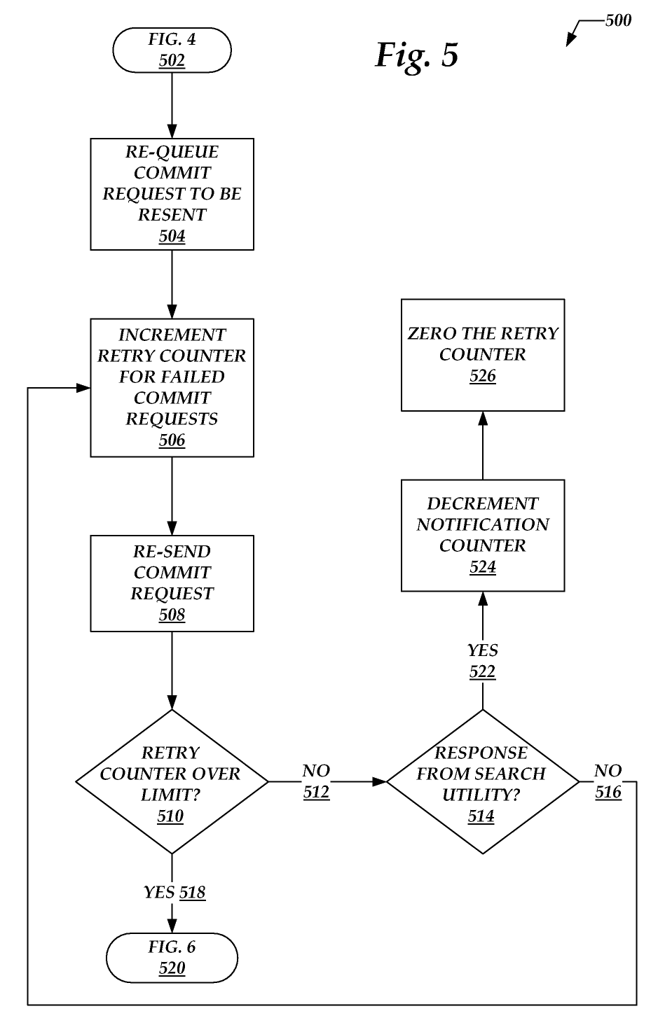

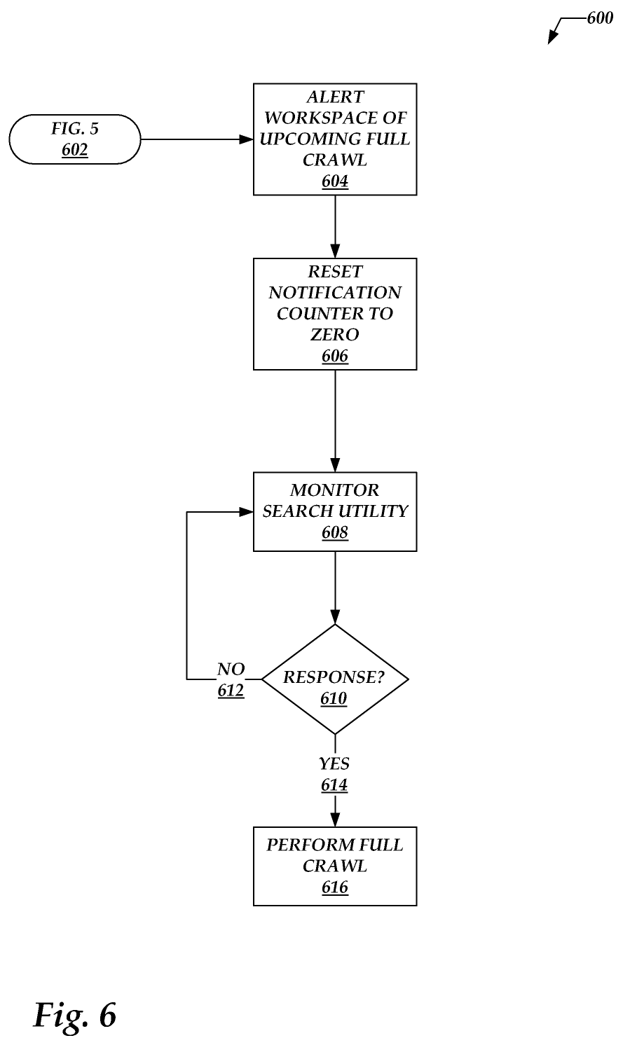

As described above, a given request to commit 216 may or may not result in a successful commit operation between the elaboration database 206 and the search database 218. FIG. 4 illustrates process flows related to successful commit operations, while FIGS. 5 and 6 illustrate process flows related to unsuccessful commit operations.

FIG. 4 illustrates process flows, denoted generally at 400, related to asynchronous database updates between client applications and search utilities, particularly in cases when a given commit operation is successful. For ease of reference and description, the process flows 400 are described in connection with the asynchronous update utility 116. However, implications of this description may perform at least portions of the process flows 400 other components without departing from the scope and spirit of this description. In addition, FIG. 4 carries forward a representative search utility 118, which may provide a response 216 to a given commit request.

Turning to the process flows 400 in more detail, block 402 represents receiving a status of a given request to commit updates to the search utility 118. As described above, the reference 216 represents requests to commit the updates, as well as responses to these requests. In different scenarios, block 402 may include receiving an explicit signal from the search utility 118. In other scenarios, block 402 may include inferring that the search utility 118 has failed or become unresponsive, without the search utility 118 explicitly generating a signal so indicating. For example, if the search utility 118 fails to respond to a given request to commit 216 within a given time window, block 402 may include inferring that the search utility 118 did not successfully process one or more request to commit 216.

Decision block 404 represents evaluating whether a given request to commit 216 was successfully processed. In some scenarios, block 404 may include evaluating an explicit signal received from the search utility 118, indicating success or failure. In other scenarios, block 404 may include inferring failure from particular circumstances surrounding the given request to commit 216. For example, block 404 may include referring to the notification counter incremented as discussed above in block 306 of FIG. 3. If this notification counter remains positive for some period of time, or is positive when the client application 114 and/or the asynchronous update utility 116 starts up, then this may indicate that one or more request to commit 216 have failed. A counter that remains incremented for a relatively long time, or an incremented counter that is detected upon application start-up, may indicate transactions that failed to commit. In any of these scenarios relating to an incremented counter, a full crawl process may be initiated to traverse the workspaces.

From decision block 404, if a given request to commit updates was processed successfully, the process flows 400 may take Yes branch 406 to block 408. Block 408 represents identifying a workspace associated with the successfully committed updates. Recalling the previous description of FIG. 3, block 308 represents associating an identifier with the given request to commit.

Block 410 represents notifying a workspace, from which the given request to commit updates originated, that the request to commit these updates was successful. In turn, block 412 represents decrementing the notification counter incremented above in block 306.

Referring back to decision block 404, if the request to commit was not successful, the process flows 400 may take No branch 414 to perform the process flows shown in FIGS. 5 and 6. For clarity of illustration, but not to limit possible implementations, the process flows 400 may proceed via off-page reference 416 to FIG. 5.

FIGS. 5 and 6 illustrate process flows 500 and 600 related to asynchronous database updates between client applications and search utilities. More specifically, FIGS. 5 and 6 illustrate scenarios in which a given commit operation is at least initially unsuccessful.

The process flows 500 as shown in FIG. 5 may begin where indicated by the off-page reference 502 from FIG. 4. Block 504 represents re-queuing the commit request to be re-sent to the search utility 118 by the asynchronous update utility 116. In turn, block 506 represents incrementing a retry counter that tracks how many times a given failed commit request has been re-sent to the search utility 118.

Block 508 represents re-sending the commit request to the search utility 118. decision block 510 represents evaluating whether the retry counter incremented in block 506 is over a pre-set limit on the number of re-sends that are permitted for a given commit request. From decision block 510, if the retry counter is not over the limit, the process flows 500 may take No branch 512 to decision block 514.

Decision block 514 represents evaluating whether the search utility 118 has responded, within some time limit, to the commit request that was re-sent in block 508. If the search utility 118 does not respond to the re-sent commit request within the time limit, the process flows 500 may take No branch 516 to return to block 506. Recalling previous description, block 506 represents incrementing the retry counter, and the process flows then proceed to blocks 508 and 510. From decision block 510, if the search utility 118 is unresponsive for a sufficient number of re-tries, then the process flows 500 may take Yes branch 518 to off-page reference 520. For ease of reference, further processing along Yes branch 518 is shown in FIG. 6.

In describing the above time limits and retry counters, it is noted that different implementations may employ different time limits and retry counters without departing from the scope and spirit of this description. Some implementations may omit these time limits and retry counters. Thus, these time limits and retry counters may provide optimizations to perform full crawls after a given update remains uncommitted for some time, rather than launching a full crawl after the search utility remains momentarily unresponsive.

Referring now to FIG. 6, process flows 600 may begin via off-page reference 602 from FIG. 5. Recalling previous description, the process flows 600 may begin in response to the search utility 118 being unresponsive to a predefined, limited number of re-tried requests to commit a given update.

Turning to the process flows 600 in more detail, block 604 represents alerting a workspace that originated the update that the failed commit request is attempting to commit to the search utility 118. More specifically, block 604 may include notifying the originating workspace that it will be re-processed or re-crawled to recapture updates that were not committed successfully to the search utility 118.

Block 606 represents resetting the notification counter to zero (incremented in block 306 of FIG. 3) in preparation for re-crawling the originating workspace. Afterwards, block 608 represents monitoring the search utility 118 for any indication that it has become operational and responsive again. For example, block 608 may include monitoring a status signal associated with the search utility 118, or periodically sending a ping signal to the search utility 118 and awaiting response.

Decision block 610 represents evaluating whether the search utility 118 has responded, or has otherwise indicated that it has returned to operational, responsive status. So long as the search utility 118 remains unresponsive, the process flows 600 may take No branch 612 to loop back to block 608. However, returning to decision block 610, once the search utility 118 has returned to operational status, the process flows 600 may take Yes branch 614 to block 616.

Block 616 represents performing a complete re-crawl of the workspace 202 that originated the failed commit request. The term “re-crawl” of a workspace refers to the client application 114 sending to the asynchronous update utility 116 a respective URL for all instances of information from the collaborative workspace 202 that are to be made searchable by the search utility 118. In due course, the search utility 118 may request the data corresponding to the respective URLs. In this manner, block 616 may enable the asynchronous update utility 116 to reach a state in which the collaboration database 206 is synchronized with the search database 218.

Returning now to FIG. 5, more specifically to decision block 514, if the search utility 118 successfully commits one of the retried updates, the process flows may take Yes branch 522 to block 524. Put differently, taking Yes branch 522 from decision block 514 may indicate that the search utility 118 has successfully committed the update. Block 524 represents decrementing the notification counter that was incremented in block 306 in FIG. 3, thereby indicating that one less request to commit 216 is pending. In turn, block 526 represents zeroing the retry counter that was incremented in block 506.

As will be appreciated, the client applications 114 and/or the search utilities 118 may crash, become inoperative, and then restart at different times. As a safeguard against such crashes, and to provide a measure of resilience, the asynchronous update utility 116 may generate and send some requests to commit 216 that do not represent actual updates to the collaborative workspace 202. More specifically, decrements to the counters described herein are not transactionally guaranteed (in contrast to increments to the counters). For example, the search utility could commit a change to its database, but the client application may crash before decrementing the counter. In general, decrements are not transactionally guaranteed because the counters are stored in the client application's s database 206, and changes to the search utility's s database 218 are not transactionally tied to the client's s database 206. Put differently, at least some of the request to commit 216 may be “false positives”, in the sense that they do not represent actual updates. If a crash occurs, some of these requests to commit 216 may be marked as unsuccessful, and then resubmitted and reprocessed according to the processes 500 and 600 shown in FIGS. 5 and 6.

Even if some of these re-processed requests to commit 216 do not represent actual updates, this procedure may reduce the risk that actual updates are not represented in requests to commit 216 before a crash occurs. put differently, this procedure may trade off the performance penalty of processing some “false positive” requests to commit 216, in exchange for reducing the risk of losing actual updates because of crashes.

The foregoing description provides technologies for asynchronous database updates between client applications and search utilities. Although the this description incorporates language specific to computer structural features, methodological acts, and computer readable media, the scope of the appended claims is not necessarily limited to the specific features, acts, or media described herein. Rather, this description provides illustrative, rather than limiting, implementations. Moreover, these implementations may modify and change various aspects of this description without departing from the true spirit and scope of this description, which is set forth in the following claims.

We claim:

1. Apparatus comprising at least one computer-readable storage medium having stored thereon computer-executable instructions that, when loaded into a processor and executed, cause the processor to:
receive at least one indication of an update to a collaborative workspace in which at least two users are collaborating, wherein updates to the collaborative workspace are committed to a collaboration database maintained internally by a collaboration application;
generate a request to commit the update to a search utility so that the update is searchable using the search utility, wherein the search utility maintains a search database that is decoupled from and operates independently of the collaboration database;
increment a notification counter associated with the collaborative workspace, wherein the notification counter tracks how many requests to commit updates are pending; and
send the request to commit the update to the search database asynchronously with respect to the collaboration database.

2. The apparatus of claim 1, further comprising instructions to associate an identifier with the request to commit the update and with the workspace in which the update occurred.

3. The apparatus of claim 2, further comprising instructions to report to the workspace a status of the request to commit the update by referencing the identifier.

4. The apparatus of claim 1, further comprising instructions to receive the indication from a central queue that receives update notifications from a plurality of workspaces.

5. The apparatus of claim 1, further comprising instructions to receive at least one indication that the request to commit the update is successful.

6. The apparatus of claim 5, further comprising instructions to identify the workspace associated with the successful request to commit, and further comprising instructions to notify the workspace of the successful commit request.

7. The apparatus of claim 5, further comprising instructions to decrement the notification counter in response to the indication of the successful commit request.

8. The apparatus of claim 1, further comprising instructions: to check a status of the notification counter when restarting a client application; and in response to determining that the notification counter is in an incremented state, determining that the request to commit the update is unsuccessful.

9. The apparatus of claim 8, further comprising instructions to increment a retry counter in response to the notification of the unsuccessful commit request, wherein the retry counter tracks how many times the commit request is re-submitted, and further comprising instructions to re-submit the unsuccessful commit request.

10. The apparatus of claim 9, further comprising instructions to zero the retry counter in response to determining that the resubmitted commit request is successful.

11. The apparatus of claim 9, further comprising instructions to decrement the notification counter in response to determining that the resubmitted commit request is successful.

12. The apparatus of claim 9, further comprising instructions to evaluate a number of times that the commit request is resubmitted exceeds a predefined limit.

13. The apparatus of claim 12, further comprising instructions to determine that the commit request has been resubmitted a number of times that exceeds the predefined limit.

14. The apparatus of claim 13, further comprising instructions to re-crawl the workspace in response to determining that the number of times exceeds the predefined limit.

15. A computer-based system comprising:
at least one processor;
at least one bus system; and
at least one computer-readable storage medium being coupled to communicate with the processor over the bus system, wherein the storage medium includes:
a collaboration application that enables a user of the system to participate in collaborative workflows through a collaboration workspace with at least a second user of at least a second system, wherein the collaboration application maintains a collaboration database for storing updates to the collaborative workspace;
a search utility for searching content stored within the system, wherein the search utility maintains a search database that indexes the content for searching, wherein the search database is decoupled from and external to the collaboration database; and
an asynchronous update utility for sending a request to the search utility to commit at least one of the updates to the search database asynchronously with respect to the collaboration database, to make the update searchable using the search utility.

16. The system of claim 15, wherein the asynchronous update utility is for receiving a successful status of the request to commit, based on a response from the search utility, and is for notifying the collaboration workspace of the successful status.

17. The system of claim 15, wherein the asynchronous update utility is for inferring an unsuccessful status of the request to commit, based on a failure of the search utility to respond to the request to commit within a predefined interval of time, and is for notifying the collaboration workspace of the unsuccessful status.

18. The system of claim 17, wherein the asynchronous update utility is for incrementing a retry counter in response to the notification of the unsuccessful commit request, wherein the retry counter tracks how many times the commit request is re-submitted, and is for re-submitting the unsuccessful commit request.

19. The system of claim 18, wherein the asynchronous update utility is for determining that the re-submitted commit request is processed successfully by the search utility.

20. The system of claim 19, wherein the asynchronous update utility is for zeroing the retry counter and decrementing the notification counter in response to determining that the re-cemented commit request is successful.
